(19) United States
(12) Patent Application Publication
(10) Pub. No.: US 2011/0097177 A1
(43) Pub. Date: Apr. 28, 2011

(54) Ball mount having center fastener

(76) Inventor: Jeffrey D. Carnevali, Seattle, WA (US)

(21) Appl. No.: 12/589,745

(22) Filed: Oct. 28, 2009

(51) Int. Cl. F16B 37/14; B23P 17/00

(52) U.S. Cl. 411/372.5; 29/527.1

(57) ABSTRACT

A novel ball mount assembly having a semi-spherical mounting ball formed of a material which renders the mounting ball relatively radially compressible; an insert formed with a stand-off positioned to extend from an outer spherical surface of the mounting ball, and a counter-bore communicating with an outer spherical surface of the mounting ball substantially opposite from the stand-off, and further having an internal bore communicating between an opening in an end of the stand-off distal from the mounting ball and a seat of the counter-bore; and a fastener formed of a threaded shaft and a head positioned on one end thereof, wherein the threaded shaft is sized to extend from the opening in the distal end of the stand-off of the insert when the head thereof is seated against the seat of the counter-bore.

### FIELD OF THE INVENTION

The present invention relates generally to ball mounts for use with socket clamps, and in particular to mounting balls for use with central fasteners for mounting on vehicles, such as motorcycles, all terrain vehicles (ATVs) and the like.

### BACKGROUND OF THE INVENTION

Ball mount devices are generally well-known for use with socket clamps. However, such known devices are limited in their ability to provide a convenient mounting means for positioning within easy reach of a vehicle operator or other user.

### SUMMARY OF THE INVENTION

The present invention is a novel ball mount assembly having a semi-spherical mounting ball formed of a material which renders the mounting ball relatively radially compressible; an insert formed with a stand-off positioned to extend from an outer spherical surface of the mounting ball, and a counter-bore communicating with an outer spherical surface of the mounting ball substantially opposite from the stand-off, and further having an internal bore communicating between an opening in an end of the stand-off distal from the mounting ball and a seat of the counter-bore; and a fastener formed of a threaded shaft and a head positioned on one end thereof, wherein the threaded shaft is sized to extend from the opening in the distal end of the stand-off of the insert when the head thereof is seated against the seat of the counter-bore.

According to one aspect of the invention a method is provided for forming the novel ball mount assembly.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the novel ball mount assembly;

FIG. 2 is a perspective cross-section view of the novel ball mount assembly;

FIG. 3 illustrates one embodiment of an insert for use with the novel ball mount assembly;

FIG. 4 illustrates a mounting ball formed onto the insert illustrated in FIG. 3;

FIG. 5 is a bottom perspective view of the insert illustrated in FIG. 3;

FIG. 6 is a perspective view of the mounting ball projected on end of a stand-off; and

FIG. 7 illustrates an alternative embodiment of the novel ball mount assembly.

### DETAILED DESCRIPTION OF PREFERRED EMBODIMENT

In the Figures, like numerals indicate like elements.

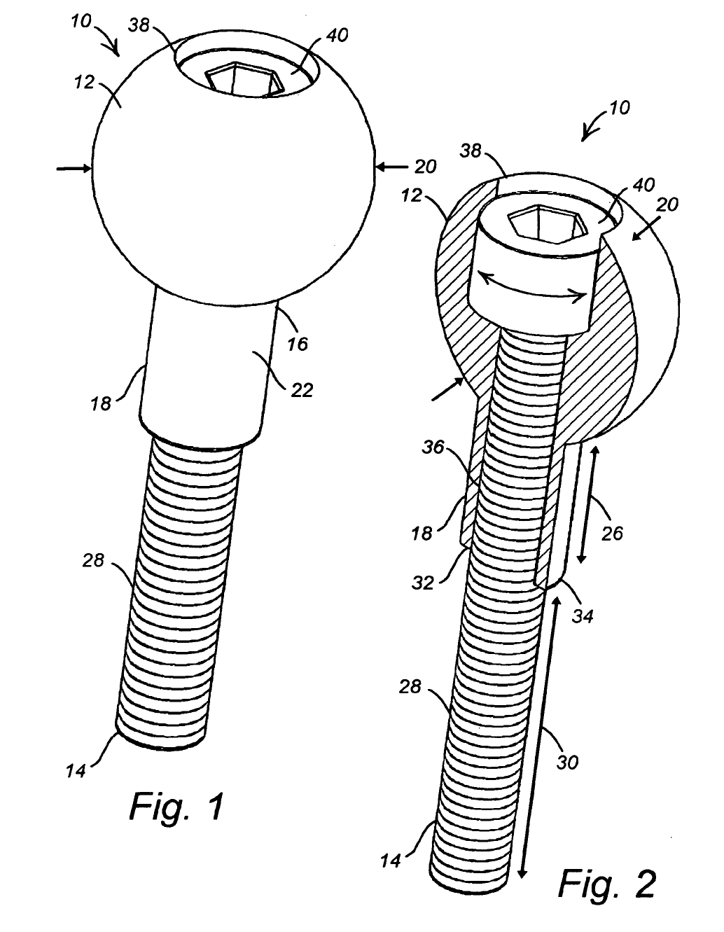

FIG. 1 is a perspective view of a ball mount assembly 10 for mounting on vehicles such as on the handlebar of a motorcycle, all terrain vehicle (ATV) or the like. Ball mount assembly 10 includes a semi-spherical mounting ball 12 formed of a relatively resilient, pressure deformable elastomeric material which renders mounting ball 12 relatively radially compressible between the respective part spherical surfaces of a socket clamp coupled thereto. Such a socket clamp is disclosed by the inventor of the present invention in U.S. Pat. No. 5,885,845 entitled, Universally Positionable Mounting Device, issued Dec. 8, 1998, which is incorporated herein by reference. The material is optionally formed of nitrile rubber material. Other suitable materials, including other hardened rubber and elastomer materials, may be employed. The materials of mounting ball 12 may have a Shore A durometer of between about 30-100 and preferably between about 60-100. Most preferable is a Shore A durometer of about between 85-90. Mounting ball 12 may have a Shore D hardness of between 40 and 70.

Semi-spherical mounting ball 12 is adapted for use with a central fastener 14 for securing to a fixed structure such as a handlebar by threadedly affixing to a threaded hole pre-existing thereon. For example, fastener 14 is a conventional socket head cap screw or the like. As illustrated, mounting ball 12 is projected on one end 16 of a stand-off 18 sized larger than central fastener 14 such that fastener 14 passes therethrough and is surrounded thereby. As illustrated here, stand-off 18 is sized narrower than an outer spherical diameter 20 of mounting ball 12 so as to interfere as little as possible with rotation thereabout of a socket clamp coupled thereto. Such a socket clamp is disclosed in U.S. Pat. No. 5,885,845, which is incorporated herein by reference. According to one embodiment, stand-off 18 is a tube having an exterior surface 22 formed smaller than outer spherical diameter 20 of mounting ball 12, and a substantially concentric internal bore 24 larger than fastener 14. See, FIG. 2. For example, exterior surface 22 is substantially cylindrical. Length 26 of stand-off 18 is shorter than threaded shaft 28 of fastener 14 such that a useful threaded length 30 of fastener 14 extends from an opening 32 terminating a second end 34 of stand-off 18 distal form mounting ball 12.

As illustrated in FIG. 2, internal bore 24 of stand-off 18 is extended through mounting ball 12 as internal bore 36 concentric therewith. Bore 36 terminates in counter-bore 38 communicating with outer spherical diameter 20 of mounting ball 12 substantially opposite from stand-off 18. Counter-bore 38 is sized to receive thereinto a head portion 40 of fastener 14 on the end of its threaded shaft 28. When fastener 14 is a conventional socket head cap screw or the like head portion 40 thereof is cylindrical, and counter-bore 38 is sized such that cylindrical fastener head 40 spins freely therein. Counter-bore 38 is recessed into outer spherical diameter 20 of mounting ball 12 such that fastener head portion 40 is at lease flush with, or even recessed below, outer spherical diameter 20, whereby fastener 14 does not interfere with rotation thereabout of a socket clamp coupled thereto.

As disclosed, ball mount assembly 10 can be mounted on vehicles such as on the handlebar of a motorcycle, all terrain vehicle (ATV) or the like by removing an existing fastener on the vehicle handlebar and substituting therefore fastener 14 with mounting ball 12 extending away from the handlebar on stand-off 18. Such substitution is accomplished without altering the pre-existing features of the handlebar nor an equipment attached thereto, but merely substituting one fastener 14 for a pre-existing fastener. Thereafter, mounting ball 12 is attached in a desired location accessible for coupling a socket clamp thereto.

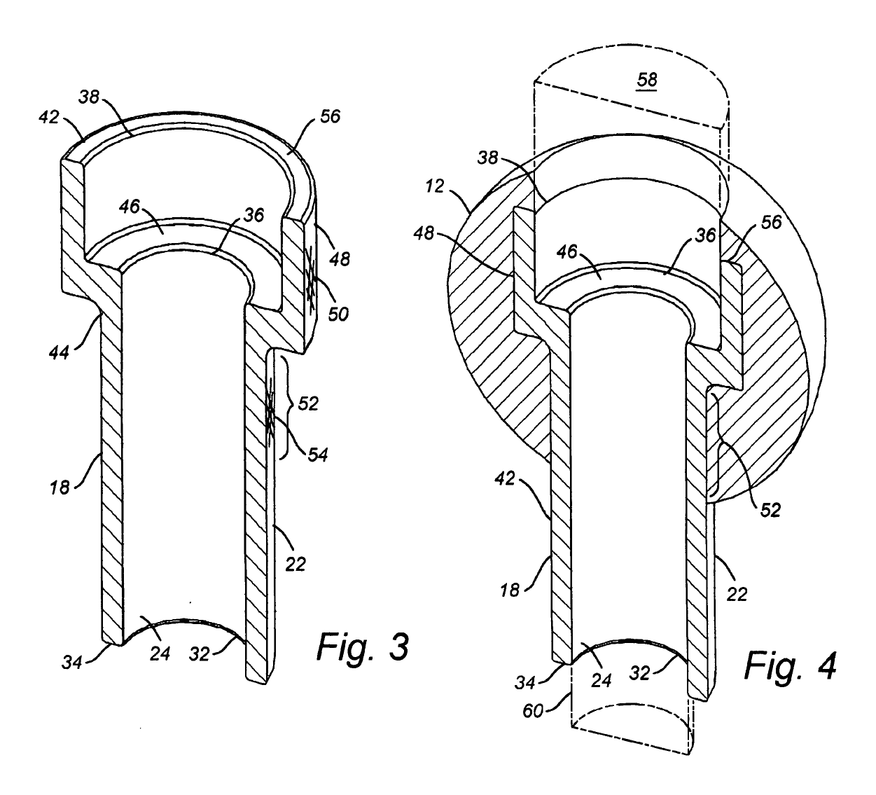

FIG. 3 illustrates one embodiment of an insert 42 which includes stand-off 18 and counter-bore 38 adjacent to a first end 44 thereof. Stand-off 18 portion of insert 42 is formed with exterior surface 22 outside substantially concentric with internal bore 24. Optionally, stand-off portion 18 of insert 42 is a substantially cylindrical tube formed with exterior surface 22 substantially concentric with internal bore 24 and smaller than outer spherical diameter 20 of mounting ball 12. Internal bore 24 of stand-off portion 18 extends into internal bore 36 concentric therewith as a single bore having opening 32 terminating second end 34 of stand-off 18 distal from counter-bore 38. Optionally, a head portion 43 provided at first end 44 of insert 42 is enlarged relative to exterior surface 22 of stand-off portion 18 whereby counter-bore 38 is formed therein substantially concentric with internal bore 36 and internal bore 24 of stand-off portion 18. Counter-bore 38 is formed with a seat 46 sized to receive head portion 40 of fastener 14.

Optionally, an outer surface 48 of head portion 43 is formed with knurling 50 or other roughening for more securely adhering molded material of mounting ball 12 bonded or otherwise coupled thereto. Additionally, a portion 52 of exterior surface 22 of stand-off portion 18 proximate to head portion 43 is optionally covered with molded material of mounting ball 12. Accordingly, proximate portion 52 of exterior surface 22 of stand-off portion 18 is formed with knurling 54 or other roughening for more secure adhering molded material of mounting ball 12.

FIG. 4 illustrates mounting ball 12 formed onto outer surface 48 of head portion 43 of insert 42 having counter-bore portion 38 formed therein and, optionally, onto proximate portion 52 of exterior surface 22 of stand-off portion 18 of insert 42. As illustrated, mounting ball 12 is sized and positioned on insert 42 such that outer surface 48 of head portion 43 is completely covered by mounting ball material, and a terminal lip 56 thereof is flush with or recessed (shown) within outer spherical diameter 20 of mounting ball 12 so it does not interfere with rotation thereabout of a socket clamp coupled thereto. See, e.g., U.S. Pat. No. 5,885,845, which is incorporated herein by reference.

Mounting ball 12 is, for example, overmolded onto outer surface 48 of head portion 43 of insert 42 having counter-bore portion 38 formed therein and, optionally, onto proximate portion 52 of exterior surface 22 of stand-off portion 18 of insert 42. Knurling 50 and 54, if present, aid in securely adhering molded material of mounting ball 12.

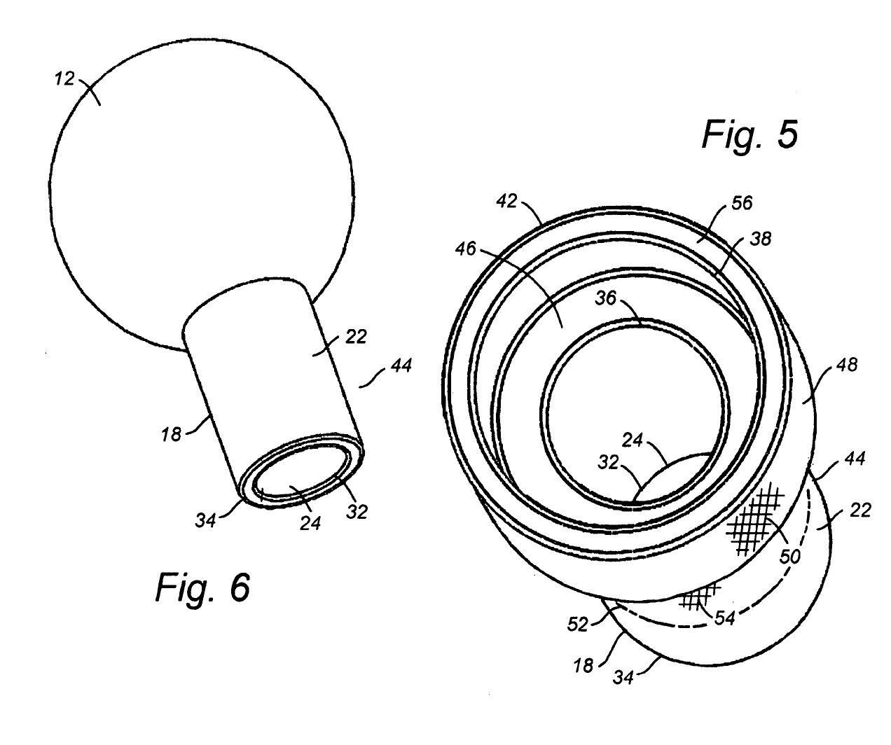

FIG. 5 is a perspective view of insert 42 illustrated in FIG. 3. FIG. 5 more clearly illustrates knurling 50 or other roughening on outer surface 48 of head portion 43 of insert 42 and, optionally, knurling 54 on proximate portion 52 of exterior surface 22 of stand-off portion 18 of insert 42 at first end 44 thereof.

FIG. 6 is a perspective view of mounting ball 12 projected on end 16 of stand-off 18 of insert 42. According to one embodiment, mounting ball 12 is molded of relatively resilient, pressure deformable elastomeric material, as disclosed herein.

As illustrated in FIG. 4, a plug 58 (phantom) may be inserted into mold to provide counter-bore portion 38 during molding of mounting ball 12 to avoid intrusion of molding material thereinto. Another plug 60 (phantom) may be inserted to provide internal bore 24. Alternatively, plugs 58 and 60 may constitute a single plug for providing both counter-bore portion 38 and both internal bores 36 and internal bore 24 communicating therewith.

Alternatively, mounting ball 12 is overmolded onto optional insert 42 of the type illustrated in FIG. 4, as disclosed herein. According to one embodiment, insert 42 is formed of a substantially rigid material metal, such as a carbon fiber composite material, or else a metal such as aluminum or steel. Optionally, either or both of outer surface 48 of head portion 43 of insert 42 having counter-bore portion 38 and portion 52 of exterior surface 22 of stand-off portion 18 at first end 44 thereof proximate to head portion 43 are provided with a roughened surface that promotes adhesion thereto of material of mounting ball 12. For example, outer surface portions 48, 52 are provided with such roughened feature as a function of the process of forming insert 42, such as casting or machining. Alternatively, knurling 50 and knurling 54 provide such roughened feature on outer surface portions 48 and 52, respectively, as a function of a secondary operation performed on insert 42.

Mounting ball 12 is overmolded or otherwise formed on outer surface 48 of adjacent to first end 44 thereof of insert 42 having counter-bore portion 38 and proximate portion 52 of exterior surface 22 of stand-off portion 18 at first end 44 thereof, for example, using injection molding or another forming process suitable for the materials selected. As illustrated in FIG. 4, plug 58 may be inserted into counter-bore portion 38 of head portion 43 of insert 42 during overmolding of mounting ball 12 to avoid intrusion of molding material thereinto. Plug 60 may be inserted into internal bore 24. When operated with insert 42, plugs 58 and 60 may constitute a single plug for providing both counter-bore portion 38 and internal bore 24 of stand-off portion 18 and internal bore 36 communicating therewith.

After molding mounting ball 12, optionally over optional insert 42 if present, threaded shaft 28 of socket head cap screw fastener 14 is inserted through counter-bore portion 38 and into internal bore 36 communicating therewith, on through internal bore 24 of stand-off portion 18. Useful threaded length 30 of fastener threaded shaft 28 is extended from opening 32 terminating distal second end 34 of stand-off portion 18 at least when head portion 40 of fastener 14 is seated against seat 46 of counter-bore 38 within mounting ball 12.

Useful threaded length 30 of fastener threaded shaft 28 extended from opening 32 of stand-off portion 18 is firmly threaded into complementary threaded receiver for securing mounting ball 12 to another structure, such as a handlebar. Optionally, threaded shaft 28 is matched to a threaded hole pre-existing on the handlebar or other structure, whereby ball mount assembly 10 is secured in position thereon without modification of the handlebar or other structure.

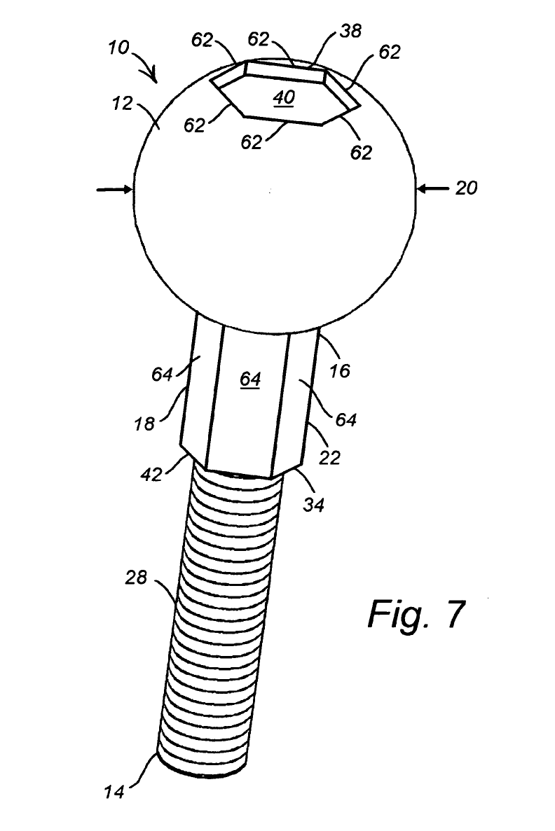

FIG. 7 illustrates counter-bore 38 in head portion 43 of insert 42 being formed in a plurality of flats 62 for receiving thereinto a square or hex head portion 40 of a hex head bolt type fastener 14. Optionally, exterior surface 22 of stand-off 18 is formed with a plurality of flats 64, whereby tubular stand-off 18 is, for example, formed with a square, hexagonal, octagonal, or twelve-sided shape for use with a conventional wrench. Driving flats 64 of exterior stand-off surface 22 with a wrench in turn drives bolt type fastener 14 through flats 62 of counter-bore 38 when insert 42 is substantially rigid.

While the preferred and additional alternative embodiments of the invention have been illustrated and described, it will be appreciated that various changes can be made therein without departing from the spirit and scope of the invention. Accordingly, the inventor makes the following claims.

What is claimed is:

1. A ball mount having a center fastener, comprising:
an insert comprising a counter-bore in a first end thereof and an opening in a second end thereof opposite from the counter-bore, and an internal bore extended from the opening through the insert into communication with the counter-bore;
a semi-spherical mounting ball adapted for use with a central securing fastener, the mounting ball being overmolded on the first end of the insert surrounding the counter-bore therein with a stand-off portion of the insert extending from an outer surface of the mounting ball, and the counter-bore communicating with the outer surface of the mounting ball opposite from the stand-off; and
a threaded fastener comprising a threaded shaft sized to fit through the internal bore of the insert and extend from the opening in the second end of the insert when a head portion of the threaded fastener is seated in the counter-bore flush or below the outer surface of the mounting ball.

2. The ball mount having a center fastener as recited in claim 1, wherein the stand-off portion of the insert further comprises an outside dimension smaller than an outer spherical diameter of the mounting ball.

3. The ball mount having a center fastener as recited claim 2, wherein the stand-off portion of the insert further comprises a substantially cylindrical tube.

4. The ball mount having a center fastener as recited claim 3, wherein a terminal lip of the counter-bore of the insert is positioned flush with or recessed within the outer spherical diameter of the mounting ball.

5. The ball mount having a center fastener as recited claim 4, wherein the insert further comprises means provided on an outer surface thereof for promoting adhesion thereto of the mounting ball.

6. A ball mount having a center fastener, comprising:
a semi-spherical mounting ball formed of a material which renders the mounting ball relatively radially compressible;
an insert comprising a stand-off positioned to extend from an outer spherical surface of the mounting ball, and a counter-bore communicating with an outer spherical surface of the mounting ball substantially opposite from the stand-off, and further comprising an internal bore communicating between an opening in an end of the stand-off distal from the mounting ball and a seat of the counter-bore; and
a fastener comprising a threaded shaft and a head positioned on one end thereof, the threaded shaft being sized to extend from the opening in the distal end of the stand-off of the insert when the head thereof is seated against the seat of the counter-bore.

7. The ball mount having a center fastener as recited in claim 6, wherein the insert further comprises a head portion adjacent to a first end of the stand-off, the head portion being enlarged relative to the stand-off portion and further comprising the counter-bore.

8. The ball mount having a center fastener as recited in claim 7, wherein the insert further comprises a substantially rigid material.

9. The ball mount having a center fastener as recited in claim 8, wherein the insert further comprises a terminal lip surrounding the counter-bore, the terminal lip being flush with or recessed within the outer spherical diameter of the mounting ball.

10. The ball mount having a center fastener as recited in claim 9, wherein the stand-off portion of the insert further comprises substantially cylindrical tube.

11. The ball mount having a center fastener as recited in claim 9, wherein the insert further comprises a substantially rigid material selected from the group of substantially rigid materials composed of: carbon fiber composite material, aluminum material, and steel material.

12. A method of forming a ball mount having a center fastener, the method comprising:
forming an insert, comprising forming a counter-bore at a first end thereof and forming an opening in a second end thereof opposite from the counter-bore, and extending an internal bore from the opening through the insert into communication with the counter-bore;
molding a semi-spherical mounting ball adapted for use with a central securing fastener, comprising overmolding the mounting ball on the insert surrounding the counter-bore thereof with a stand-off portion of the insert extending from on an outer surface of the mounting ball and the counter-bore of the insert communicating with an outer surface of the mounting ball opposite from the stand-off; and
providing a threaded fastener comprising a threaded shaft sized to fit through the internal bore of the insert and extend from the opening in the end of the stand-off portion thereof distal from the mounting ball when a head portion thereof is seated in the counter-bore flush or below the outer surface of the mounting ball.

13. The method of claim 12, wherein forming the stand-off portion of the insert further comprises forming the stand-off portion having an outside dimension smaller than an outer spherical diameter of the mounting ball.

14. The method of claim 13, wherein forming the insert further comprises forming the insert of a substantially rigid material; and
wherein molding a semi-spherical mounting ball further comprises molding the mounting ball of a relatively resilient, pressure deformable elastomeric material.

15. The method of claim 14, further comprising positioning a terminal lip of the counter-bore of the insert flush with or recessed within the outer spherical diameter of the mounting ball.

16. The method of claim 15, wherein forming an insert further comprises providing on at least a portion of an outer surface thereof means for promoting adhesion thereto of the mounting ball.

17. The method of claim 16, wherein providing means for promoting adhesion further comprises roughening the outer surface of the insert.

18. The method of claim 15, wherein overmolding the mounting ball on the stand-off further comprises further comprises plugging the internal bore and the counter-bore.

19. The method of claim 12, further comprising inserting the threaded shaft of the threaded fastener through the internal bore of the insert and extending a useful threaded portion thereof from the opening in the end of the stand-off portion thereof distal from the mounting ball and seating the head portion thereof in the counter-bore flush or below the outer surface of the mounting ball; and
threading the useful threaded portion of the threaded shaft of the threaded fastener into a pre-existing threaded hole.

20. The method of claim 19, wherein threading the useful threaded portion of the threaded shaft of the threaded fastener into a pre-existing threaded hole further comprises threading into a threaded hole pre-existing on a vehicle handlebar.
